(19) United States
(12) Patent Application Publication
(10) Pub. No.: US 2015/0362457 A1
(43) Pub. Date: Dec. 17, 2015

(54) CONTROL UNIT FOR A GAS CONCENTRATION SENSOR

(71) Applicant: DENSO CORPORATION, Kariya-city (JP)

(72) Inventor: Takumi WATANABE, Anjo-city (JP)

(21) Appl. No.: 14/681,272

(22) Filed: Apr. 8, 2015

(30) Foreign Application Priority Data
Jun. 17, 2014 (JP) 2014-124530
Mar. 13, 2015 (JP) 2015-51072

(51) Int. Cl. G01N 27/406; G01N 27/407

(52) U.S. Cl. CPC G01N 27/4065; G01N 27/407

(57) ABSTRACT

A control unit for a gas concentration sensor, in which a limiting-current flows, includes a voltage control circuit for controlling a sensor voltage, a current detection resistor for detecting a current flowing in the sensor, and a calculation circuit for calculating a temperature of the sensor. The voltage control circuit includes a sweep circuit for supplying a sweep voltage and a voltage supply circuit for supplying the sensor voltage as a feedback voltage. The calculation circuit calculates impedance of admittance based on a current variation and a voltage variation of the sensor and calculates the temperature of the sensor based on a temperature characteristic of the impedance or admittance. The voltage supply circuit controls the sensor voltage in accordance with the temperature of the sensor so that a limiting-current corresponding to the temperature of the sensor flows irrespectively of a gas to be detected.

### CROSS REFERENCE TO RELATED APPLICATION

This application is based on Japanese patent applications No. 2014-124530 filed on Jun. 17, 2014 and No. 2015-51072 filed on Mar. 13, 2015, the contents of which are incorporated herein by reference.

### FIELD

The present disclosure relates to a control unit, which controls a gas concentration sensor.

### BACKGROUND

JP 2004-251891A (US 2004/0195097 A1) discloses a gas concentration detection device, which is applied to a limiting-current type gas concentration sensor. This gas concentration detection device sets a characteristic of a voltage supplied to the gas concentration sensor (sensor voltage characteristic) based on a width of a limiting-current region at each gas concentration level.

As described above, the gas concentration detection device sets the sensor voltage characteristic based on the width of the limiting-current region at each gas concentration level. This limiting-current region indicating the region of the sensor voltage, with which the limiting-current flows, has a characteristic of variation in accordance with temperature of the gas concentration sensor. As a result, the limiting-current may not flow in the gas concentration sensor occasionally because of changes in the temperature.

The gas concentration detection device therefore sets the sensor voltage characteristic so that, in a voltage-current coordinate (V-I coordinate), a voltage (sensor voltage) supplied to the gas concentration sensor as a sensor voltage passes a region, in which limiting-currents of the same concentration level at different temperatures overlap. However, this characteristic does not vary with temperature changes. For this reason, in a case of a certain change in temperature, the limiting-current may not flow and accuracy of detecting gas concentration is lowered.

### SUMMARY

It is therefore an object to provide a control unit, which suppresses lowering of accuracy of detecting gas concentration.

According to one aspect, a control unit is provided for controlling a gas concentration sensor, in which current flows in accordance with a resistance thereof in response to a sensor voltage supplied thereto, the current saturating at a limiting-current corresponding to a concentration of a gas, which is to be detected, irrespectively of the sensor voltage supplied thereto when the sensor voltage supplied thereto exceeds a predetermined value. The control unit comprises a current detection resistor for detecting the current flowing in the gas concentration sensor and a calculation circuit for calculating a temperature of the gas concentration sensor. The calculation circuit calculates a value of the sensor voltage supplied to the gas concentration sensor in accordance with the temperature of the gas concentration sensor, so that the limiting current, which is detected by the current detection resistor and corresponds to the temperature of the gas concentration sensor calculated by the calculation circuit, flows in the gas concentration sensor irrespectively of the concentration of the gas to be detected.

### BRIEF DESCRIPTION OF THE DRAWINGS

FIG. 1 is a circuit diagram showing a control unit according to one embodiment;

FIG. 2 is a graph showing sensor currents corresponding to different concentrations;

FIG. 3 is a graph showing changes in a sensor current in correspondence to lowering of a sensor temperature;

FIG. 4 is a waveform chart showing a sweep voltage;

FIG. 5 is a waveform chart showing another sweep voltage;

FIG. 6 is a graph showing temperature dependency of impedance;

FIG. 7 is a graph showing temperature dependency of admittance;

FIG. 8 is a graph showing a first example of a sensor voltage corresponding to a sensor current shown in FIG. 3;

FIG. 9 is a second example of the sensor voltage;

FIG. 10 is a third example of the sensor voltage;

FIG. 11 is a fourth example of the sensor voltage;

FIG. 12 is a circuit diagram showing the control unit, which generates the sensor voltage shown in FIG. 8;

FIG. 13 is a circuit diagram showing a control unit, which generates the sensor voltage shown in FIG. 9;

FIG. 14 is a circuit diagram showing a control unit, which generates the sensor voltage shown in FIG. 10;

FIG. 15 is a circuit diagram showing a control unit, which generates the sensor voltage shown in FIG. 11; and

FIG. 16 is a circuit diagram showing a modification of the control unit shown in FIG. 13.

### DETAILED DESCRIPTION OF EMBODIMENT

A control unit for a gas concentration sensor will be described with reference to plural embodiments, in which the control unit controls the gas concentration sensor for detecting concentration of gas contained in exhaust gas of an internal combustion engine.

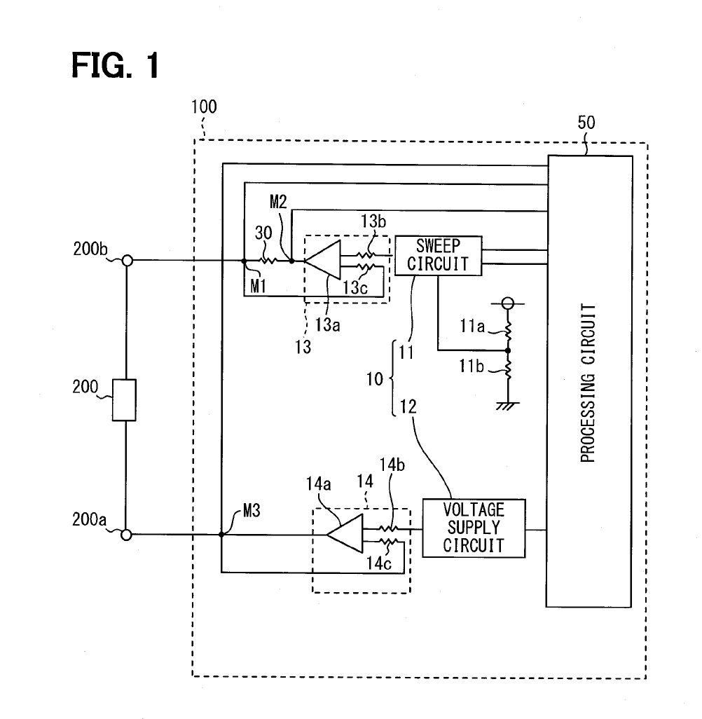

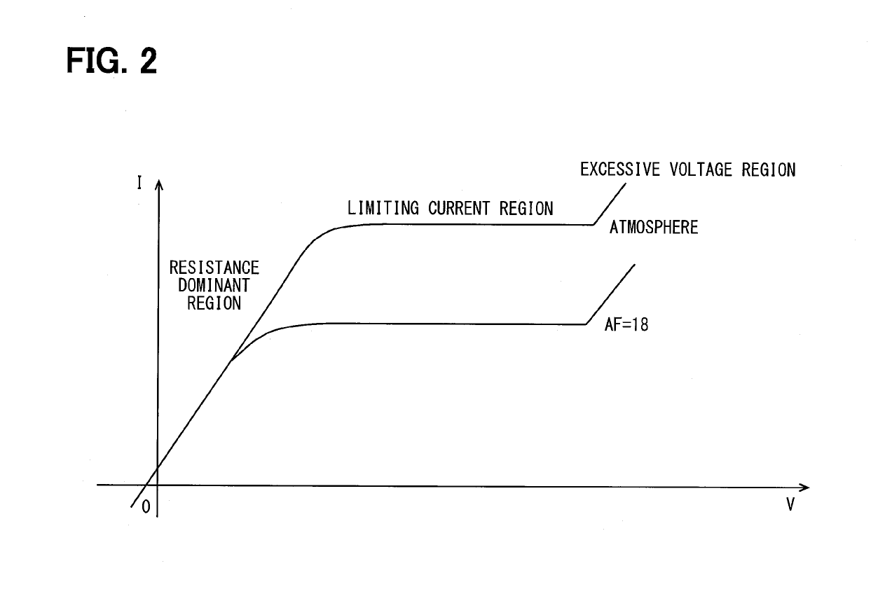

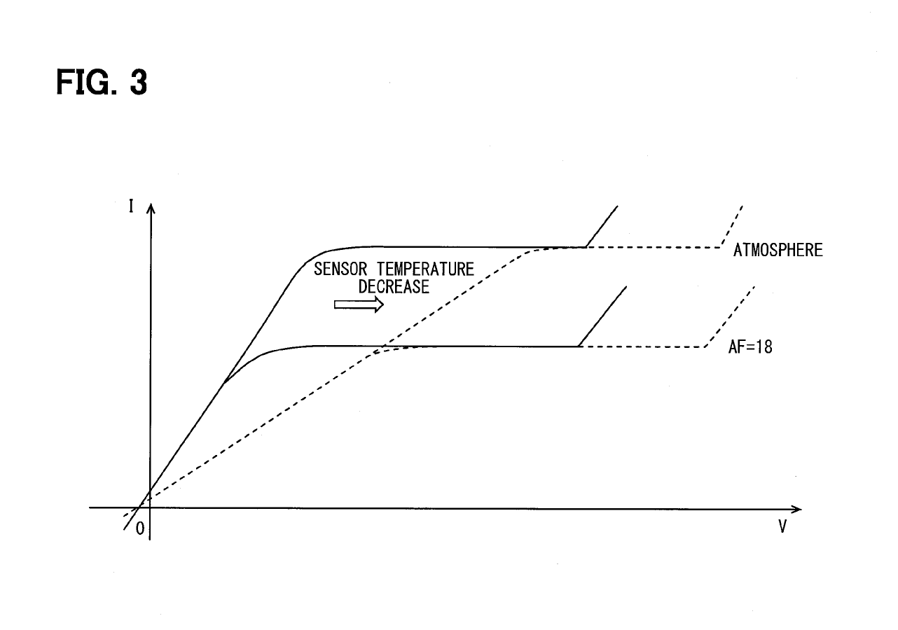

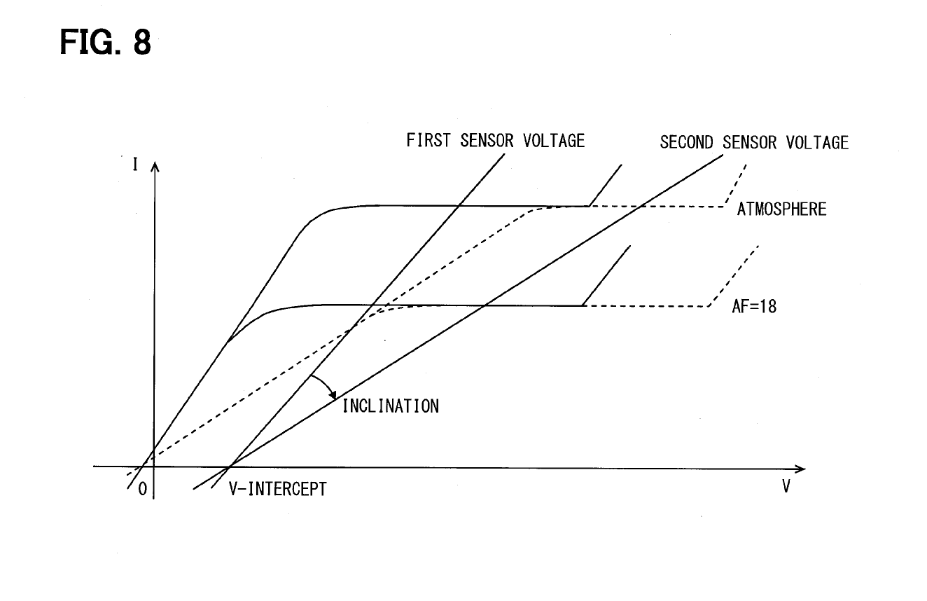

A control unit 100 according to one embodiment will be described with reference to FIG. 1 to FIG. 8. Coordinates shown in FIG. 2, FIG. 3 and FIG. 8 are V-I coordinates, each of which shows a relation between a voltage V supplied to a gas concentration sensor 200 and a current I flowing in the gas concentration sensor 200. The abscissa axis and the ordinate axis indicate a sensor voltage (supply voltage) V and a sensor current I in each coordinate, respectively. The sensor current in those figures indicates only a case that an air-fuel ratio AF is lean (AF=18, atmospheric air). Even in a case that the air-fuel ratio is rich, the sensor current varies similarly to a case of a rich air-fuel ratio. The coordinate shown in FIG. 6 shows a relation between temperature and impedance of the gas concentration sensor 200. In FIG. 6, the abscissa axis and the ordinate axis indicate temperature and impedance, respectively. The coordinate shown in FIG. 7 shows a relation between temperature and admittance of the gas concentration sensor 200. In FIG. 7, the abscissa axis and the ordinate axis indicate temperature and admittance, respectively.

The gas concentration sensor 200, which the control unit 100 controls, is provided in an exhaust pipe, in which exhaust gas emitted from an internal combustion engine flows. The gas concentration sensor 200 is a limiting-current type oxygen sensor. Although not shown, the gas concentration sensor 200 is formed by stacking on a diffusion resistance layer a first electrode, a solid electrolyte and a second electrode sequentially. The diffusion resistance layer is formed of porous alumina having micro holes. The first electrode and the second electrode are formed of platinum. The solid electrolyte is a zirconia solid electrolyte. The exhaust gas flows in the first electrode through the diffusion resistance layer. The second electrode is exposed to atmospheric air. The first electrode is connected to a second terminal 200b of the gas concentration sensor 200. The second electrode is connected to a first terminal 200a. In the following description, the first electrode and the second electrode are referred to as an exhaust-side electrode and an air-side electrode.

In the gas concentration sensor 200, the direction of a current is reversed in accordance with a ratio between air and fuel (air-fuel ratio AF) contained in exhaust gas. When the air-fuel ratio of the exhaust gas is higher (oxygen concentration is rich) than a stoichiometric air-fuel ratio, at which air and fuel react ideally in the internal combustion engine, the current flows from the air-side electrode to the exhaust-side electrode. When the air-fuel ratio is low (oxygen concentration is low), the current flows from the exhaust-side electrode to the air-side electrode. That is, the current flows from the air-side electrode to the exhaust-side electrode in the gas concentration sensor 200 when the air-fuel ratio is lean, and the current flows from the exhaust-side electrode to the air-side electrode when the air-fuel ratio is rich.

When the air-fuel ratio of the exhaust gas is higher than the stoichiometric air-fuel ratio (the air-fuel ratio of the exhaust gas is lean), an oxygen molecule contained in the exhaust gas is taken into the exhaust-side electrode. The oxygen molecule, which is taken in, is ionized and move to the solid electrolyte and then to the air-electrode through the solid electrolyte. At the air-side electrode, the ionized oxygen is restored to the oxygen molecule and emitted into air. Thus, when the air-fuel ratio of the exhaust gas is lean, the ionized oxygen flows from the exhaust-side electrode to the air-side electrode. That is, when the air-fuel ratio is lean, current flows from the air-side electrode to the exhaust-side electrode. On the other hand, when the air-fuel ratio of the exhaust gas is lower than the stoichiometric air-fuel ratio (the air-fuel ratio of the exhaust gas is rich), the oxygen molecule contained in the air is taken into the air-side electrode. The oxygen molecule, which is taken in, is ionized and move to the solid electrolyte and then to the exhaust-side electrode through the solid electrolyte. At the exhaust-side electrode, the ionized oxygen is restored to the oxygen molecule and emitted into the exhaust gas. The oxygen molecule emitted from the exhaust-side electrode react with unburned gases (carbon monoxide, hydrogen chloride and the like) contained in the exhaust gas. Thus, when the air-fuel ratio of the exhaust gas is rich, the ionized oxygen flows from the air-side electrode to the exhaust-side electrode. That is, when the air-fuel ratio is rich, a current flows from the exhaust-side electrode to the air-side electrode.

As shown in FIG. 2, when the sensor voltage (supply voltage) V is low, a current value of the sensor current I flowing in the gas concentration sensor 200 increases gradually with an increase in the sensor voltage. The rate of current increase varies with a resistance of the gas concentration sensor 200. However, when the sensor voltage exceeds a predetermined value, mobility of the ionized oxygen is limited by the diffusion resistance layer and the sensor current saturates. This is because, when the air-fuel ratio of the exhaust gas is lean, the oxygen molecule contained in the exhaust gas, which is taken in, is limited by the diffusion resistance layer. Further, this is because, when the air-fuel ratio of the exhaust gas is rich, reaction of the unburned gas with the oxygen molecules is limited by the diffusion resistance layer. As a result, the sensor current saturates irrespectively of the air-fuel ratio of the exhaust gas and the limiting-current flows in the gas concentration sensor 200. As shown in FIG. 2, the current value of the limiting-current is in direct proportion to the oxygen concentration (air-fuel ratio) contained in the exhaust gas. It is therefore possible to detect the oxygen concentration by detecting the limiting-current. When a much higher excessive voltage is supplied to the gas concentration sensor 200, in which the limiting-current flows, the sensor current starts to increase further from the limiting-current. This is because, water contained in the exhaust gas starts to be decomposed by electrolysis at the first electrode when the air-fuel ratio of the exhaust gas is lean, and the unburned gas contained in the exhaust gas starts to react at the first electrode when the air-fuel ratio of the exhaust gas is rich.

In the following description, in the V-I coordinate shown in FIG. 2, a region in which a current flows in accordance with a resistance value and a sensor voltage is indicated as a resistance-dominant region, a region in which a limiting-current flows irrespective of a sensor voltage is indicated as a limiting-current region, and a region in which a current higher than a limiting-current is indicated as an excessive voltage region. A width of a limiting-current region is determined by a first voltage (predetermined value) required for the limiting-current to flow and a second voltage required for a current larger than the limiting-current to start to flow.

As described above, the sensor current depends on the resistance value and the sensor voltage in the resistance dominant region. The resistance value of the gas concentration sensor 200 is in inverse proportion to the temperature of the sensor (referred to as a sensor temperature below). For this reason, the resistance value increases with a decrease in the sensor temperature and a rate of variation (inclination or slope) of the sensor current in the resistance dominant region. As the sensor current of low temperature is shown by a dotted line in FIG. 3, the first voltage increases as the sensor temperature falls. It is thus required to supply higher voltage so that the limiting-current flows in the gas concentration sensor 200. The first voltage thus varies with the sensor voltage in an inversely proportional characteristic.

In the following description, each structural circuits of the control unit 100 for controlling the gas concentration sensor 200 will be described.

As shown in FIG. 1, the control unit 100 includes a voltage control circuit 10, a current detection resistor 30 and a processing circuit 50, which may be a programmed digital computer such as a microcomputer including a CPU and memories. The voltage control circuit 10 is for controlling a voltage supplied to the gas concentration sensor 200. The current detection resistor 30 is for detecting a current flowing in the gas concentration sensor 200. The processing circuit 50 is for controlling the voltage control circuit 10 and for calculating the temperature of the gas concentration sensor 200.

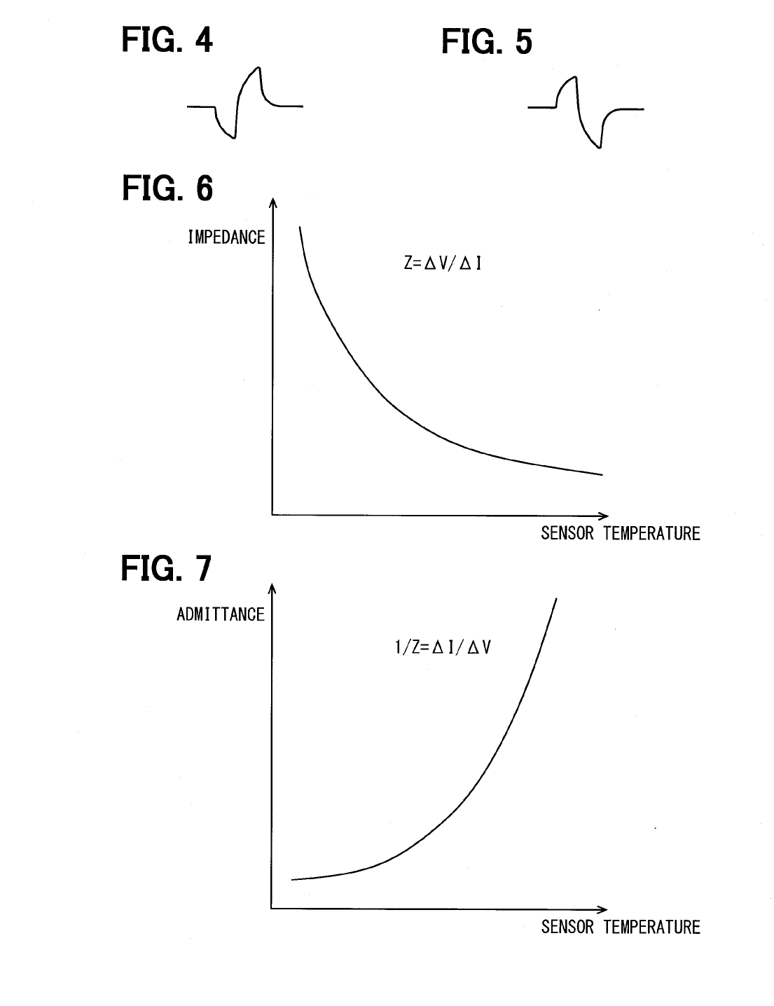

The voltage control circuit 10 includes a sweep circuit 11 and a voltage supply circuit 12. The sweep circuit 11 supplies the gas concentration sensor 200 with a sweep voltage, a voltage value of which varies with time and reverses in positive and negative directions as shown exemplarily in FIG. 4 and FIG. 5. The voltage supply circuit 12 supplies the gas concentration sensor 200 with a voltage so that the limiting-current flows as shown in FIG. 8. The voltage supply circuit 12 supplies a sensor voltage (also referred to as a feedback voltage) corresponding to the sensor temperature and the sensor current to the gas concentration sensor 200. This time variation is in an order of milliseconds. On the contrary, a time variation of the sweep voltage supplied from the sweep circuit 11 is in an order of microseconds. The sweep voltage thus varies rapidly with time relative to the sensor voltage. While the sensor voltage is being supplied between the terminals 200a and 200b continuously to detect the oxygen concentration, the sweep voltage is supplied only periodically, that is, intermittently. While the sweep voltage is being supplied, the processing circuit 50 detects a quantity of time variation of the sensor current ΔI and a quantity of time variation of the voltage ΔV supplied to the gas concentration sensor 200 so that the impedance or admittance of the oxygen concentration sensor 200 is detected.

As shown in FIG. 6 and FIG. 7, impedance Z and admittance Y, which is a reciprocal 1/Z of the impedance, of the gas concentration sensor 200 have temperature dependent characteristics. That is, the impedance has a characteristic of an inverse proportion to the sensor temperature and the admittance has a characteristic of a proportion to the sensor temperature. It is thus possible to calculate the impedance or the admittance and calculate the sensor temperature based on the calculated impedance or admittance and the characteristic of temperature dependency shown in FIG. 6 or FIG. 7. The impedance or the admittance can be calculated based on quantities of time variations ΔI, ΔV of the sensor current and the sensor voltage at the time of supplying the sweep voltage.

It is noted that the voltage value of the sweep voltage is reversed from a negative value to a positive value as shown in FIG. 4. This is caused because the gas concentration sensor 200 discharges its charge stored therein in response to the supply of the sweep voltage. The gas concentration sensor 200 stores charge in response to the supply of the sensor voltage. However, since a quantity of time variation of the sensor voltage is smaller than that of the sweep voltage, the stored charge discharges by itself. For this reason, as opposed to the case of the supply of the sweep voltage, the polarity of the sensor voltage is not reversed to discharge the charge stored in the gas concentration sensor 200. It is however allowable to reverse the voltage value of the sweep voltage from positive to negative as shown in FIG. 5.

The voltage supply circuit 12 is a DA conversion circuit, which converts a digital signal outputted from the processing circuit 50 to an analog signal and supply a voltage of a converted signal to the gas concentration sensor 200. For this reason, the voltage supply circuit 12 does not generate the sensor voltage, which has a voltage characteristic shown in FIG. 8. The processing circuit 50 generates the sensor voltage having such a voltage characteristic. The voltage supply circuit 12 and the processing circuit 50 form jointly a voltage supply circuit.

The processing circuit 50 detects the sensor current and the sensor voltage, which are generated when the sweep voltage is not supplied. Although the limiting-current flows in the gas concentration sensor 200 as described above, it is dependent on the air-fuel ratio. It is thus possible to detect the air-fuel ratio by detecting the sensor current (sensor current when the current value is constant irrespective of the voltage value of the sensor voltage), which flows when the limiting-current flows in response to the supply of the sensor voltage. The gas concentration sensor 200 generates an electromotive force, which increases to be higher when the air-fuel ratio is rich than when the air-fuel ratio is stoichiometric and decreases to be lower when the air-fuel ratio is lean than when the air-fuel ratio is stoichiometric. It is thus also possible to detect the air-fuel ratio by detecting the voltage value of the electromotive force when the variation of the electromotive force relative to the air-fuel ratio is slow. The quantity of variation of the electromotive force relative to the air-fuel ratio may be determined by material and structure of the diffusion resistance layer.

As shown in FIG. 1, the voltage control circuit 10 includes, in addition to the sweep circuit 11 and the voltage supply circuit 12, a first buffer 13 for the sweep circuit 11 and a second buffer 14 for the voltage supply circuit 12. The first buffer 13 has a first operational amplifier 13a and input resistors 13b, 13c. The second buffer 14 has a second operational amplifier 14a and input resistors 14b, 14c. An output terminal of the first operational amplifier 13a is connected to the second terminal 200b through the current detection resistor 30. One of the two input terminals of the first operational amplifier 13a is connected to the sweep circuit 11 through the resistor 13b. The other of the input terminals is connected to a first midpoint M1, which is a junction point between the current detection resistor 30 and the second terminal 200b. With this configuration, the first midpoint M1 is maintained at the same potential as the voltage outputted from the sweep circuit 11.

A midpoint voltage between the two resistors 11a and 11b connected in series from a power supply source to the ground is inputted to the sweep circuit 11 as a fixed voltage. During a period, in which the sweep voltage is not supplied from the sweep circuit 11, the midpoint voltage between the resistors 11a and 11b is outputted from the sweep circuit 11 as the fixed voltage. However, in the period of no supply of the sweep voltage from the sweep circuit 11, the potential at the first midpoint M1 is at the same potential as the midpoint voltage between the resistors 11a and 11b and constant. However, in the period of supply of the sweep voltage form the sweep circuit 11, the potential of the first midpoint M1 is the same as that of the sweep voltage and variable with time. A potential at a second midpoint M2 between the current detection resistor 30 and the first operational amplifier 13a varies with the sensor current irrespectively of the supply of the sweep voltage. It is thus possible to detect the sensor current corresponding to the sensor voltage by detecting a variation of the potential at the second midpoint M2 relative to that at the first midpoint M1 in the period of no supply of the sweep voltage from the sweep circuit 11. It is also possible to detect the sensor current corresponding to the sweep voltage by detecting the variation of the potential at the second midpoint M2 relative to that of the first midpoint M1 in the period of the supply of the sweep voltage from the sweep circuit 11.

The second buffer 14 has the same configuration as that of the first buffer 13. An output terminal of the second operational amplifier 14a is connected to the first terminal 200a. One of the two input terminals of the second operational amplifier 14a is connected to the voltage supply circuit 12 through the resistor 14b. The other of the input terminals is connected to a third midpoint M3 between the output terminal of the second operational amplifier 14a and the first terminal 200a through the input resistor 14c. With this configuration, the third midpoint M3 is maintained at the same potential as the voltage outputted from the circuit 12. Voltages at the midpoint M1 and M3 are supplied to the gas concentration sensor 200. The sensor voltage therefore equals a voltage, which results from subtraction of the voltage at the third midpoint M3 from the voltage at the first midpoint M1.

The current detection resistor 30 is provided between the second terminal 200b and the output terminal of the first operational amplifier 13a. The potential of the current detection resistor 30 at the second terminal 200b side is the same as that at the first midpoint. The potential of the current detection resistor 30 at the first operational amplifier 13a side is the same as that at the second midpoint M2. In the following description, the voltages at the midpoints M1 to M3 are indicated as midpoint voltages V1 to V3, respectively.

The processing circuit 50 controls driving of the voltage control circuit 10 and detects the sensor temperature. The processing circuit 50 supplies the gas concentration sensor 200 with the sweep voltage by driving the sweep circuit 11 at a predetermined period irrespective of the driving state of the voltage supply circuit 12 (voltage value of the sensor voltage). The processing circuit 50 prestores at least one of the temperature characteristic of the impedance of the gas concentration sensor 200 as shown in FIG. 6 and the admittance of the gas concentration sensor 200 as shown in FIG. 7 as well as the resistance value of the current detection resistor 30. The processing circuit 50 detects the midpoint voltages V1 to V3 while the sweep circuit 11 supplies the sweep voltage. The processing circuit 50 detects the quantity of time variation of the sensor current ΔI based on the quantity of time variation of the voltage difference V1-V2 and the resistance value of the current detection resistor 30. The processing circuit 50 also detects the quantity of time variation of the sensor voltage ΔV based on the quantity of time variation of the voltage difference V1-V3. The processing circuit 50 finally calculates the impedance or the admittance of the gas concentration sensor 200 based on the quantity of the time variation of the sensor current ΔI and the quantity of the time variation of the sensor voltage ΔV and calculates the sensor temperature based on the temperature characteristic shown in FIG. 6 or FIG. 7. The processing circuit 50 is thus a digital arithmetic calculation circuit.

The processing circuit 50 controls the sensor voltage based on the calculated sensor temperature. That is, the processing circuit 50 feedback-controls a digital signal, which is outputted to the voltage supply circuit 12 in accordance with the sensor temperature so that the limiting-current corresponding to the sensor temperature flows in the gas concentration sensor 200 irrespective of the air-fuel ratio. The voltage supply circuit 12, which is a digital-analog (DA) conversion circuit, converts this digital signal to the analog signal. The sensor voltage described above is supplied to the gas concentration sensor 200 through the second buffer 14. In the following description, it is simply described as the sensor voltage is outputted from the processing circuit 50.

The processing circuit 50 controls the sensor voltage in correspondence to the sensor current. The inclination of the sensor voltage, which is calculated by dividing the quantity of the current variation by the quantity of the voltage variation, is increased and decreased in correspondence to an increase and a decrease of the sensor temperature in the V-I coordinate as shown in FIG. 8. For generating the sensor voltage having the above-described characteristic, the following processing is performed in advance. That is, a temperature of the gas concentration sensor 200 is divided into first to N-th temperature regions, with N being a natural number equal to 2 or more. First to N-th sensor voltages are generated in correspondence to the first to N-th temperature regions. The sensor voltages in the number of N are prestored in the processing circuit 50. With k being a natural number, which is equal to or larger than 1 and equal to or smaller than N, the processing circuit 50 outputs the k-th sensor voltage in a case that the sensor temperature is in the k-th temperature region. The first to N-th sensor voltages are so determined that the limiting-current flows in the first to N-th temperature regions, respectively.

In the present embodiment, the sensor voltage is expressed as a linear line in the V-I coordinate. The inclination of the sensor voltage is adjusted in correspondence to the sensor temperature as shown in FIG. 8. In the present embodiment, N is 2. The processing circuit 50 therefore prestores the first sensor voltage and the second sensor voltage, which correspond to the first temperature region and the second temperature region, respectively. In FIG. 8, the sensor current indicated by a solid line shows one example of the sensor current in the first temperature region and the sensor current indicated by a dotted line shows one example of the sensor current in the second temperature region. The second temperature region is lower than the first temperature region. The inclination of the second sensor voltage is smaller than that of the first sensor voltage. Thus the inclination of the sensor voltage is pre-adjusted to increase and decrease in accordance with an increase and a decrease of the sensor temperature. The inclination of the sensor voltage is pre-adjusted to be directly proportional to the sensor temperature.

It is noted that the characteristic (inclination) of the sensor voltage in each of the above-described temperature regions is determined in the following manner. Assuming that L is a natural number, which is equal to 2 or more, the k-th temperature region is equally divided by the natural number L, and first to L-th measurement temperatures are determined. In each of the first to L-th measurement temperatures, a voltage which has a characteristic of allowing the limiting-current to flow irrespectively of the oxygen sensor is calculated. Next, among the calculated voltages having plural characteristics, a voltage having a common characteristic for each of the first to L-th measurement temperatures is selected. With this selection, the k-th sensor voltage having the characteristic (inclination) that allows the limiting-current to flow irrespectively of the oxygen concentration in the k-th temperature region is determined. This determination method is summarized as follows. That is, sensor currents corresponding to oxygen concentrations in each of the first to L-th measurement temperatures in the V-I coordinate are plotted. A linear line, which passes the limiting-current of each of the plural sensor currents, is set. Thus the characteristic of the k-th sensor voltage is determined.

Assuming that a voltage, which is in the center between the first voltage and the second voltage determining the limiting-current is an intermediate voltage, the sensor voltage characteristic is determined so that the characteristic passes the intermediate voltage in the V-I coordinate. It becomes difficult of course to set the sensor voltage characteristic to pass the intermediate voltages of all the sensor currents in a case that the sensor currents are three or more. However, the sensor voltage characteristic is determined so that the characteristic passes near the intermediate voltage of the limiting-current of the plural sensor currents in the above-described one temperature region. That is, the sensor voltage characteristic is determined so that a distance of separation between the intermediate voltage of the sensor currents and the sensor voltage is minimized.

The processing of the processing circuit 50 is summarized as follows. The processing circuit 50 calculates the sensor temperature as described above. The processing circuit 50 then determines to which one of the plural temperature regions the calculated sensor temperature belongs. The processing circuit 50 supplies the gas concentration sensor 200 with the sensor voltage, which corresponds to the determined temperature region, so that the limiting-current flows in the gas concentration sensor 200. The processing circuit 50 finally detects the limiting-current thereby to detect the oxygen concentration in the exhaust gas. Alternatively, the processing circuit 50 detects the electromotive force of the gas concentration sensor 200 thereby to detect the air-fuel ratio. The electromotive force of the gas concentration sensor 200 is determined based on the third midpoint voltage V3.

The control apparatus 100 according to the present embodiment provides the following operation and advantage. As described above, the sensor voltage is feedback-controlled based on the sensor temperature so that the limiting-current corresponding to temperature flows in the gas concentration sensor 200 irrespectively of the oxygen concentration in the exhaust gas. Thus, even when the temperature changes, the limiting-current can continue to flow in the gas concentration sensor 200 and the accuracy of detecting the oxygen concentration can be maintained without lowering. That is, robustness in detecting the gas concentration can be improved.

As described above, the inclination of the sensor current in the V-I coordinate becomes large as the temperature rises and small as the temperature falls. The processing circuit 50 increases and decreases the inclination of the sensor voltage in correspondence to the increase and decrease in the sensor temperature. For this reason, the inclination of the sensor voltage increases as the temperature rises and decreases as the temperature falls. Thus, the sensor voltage is controlled to follow the time variation of the sensor current and the sensor temperature. As a result, even when the temperature changes, it is possible to suppress the limiting-current from being disabled to flow in the gas concentration sensor 200 and suppress the accuracy of detecting the oxygen concentration in the exhaust gas from being lowered. That is, robustness in detecting the oxygen concentration in the exhaust gas can be improved.

In the V-I coordinate, the sensor voltage characteristic is determined so that the distance of separation between the intermediate voltage among the plural sensor currents and the sensor voltage is minimized. Thus it is suppressed that the limiting-current is disabled to flow in the gas concentration sensor 200 because of the variation of the first voltage caused by a sudden rise of temperature or the like in comparison to a case, in which a voltage between the first voltage and the intermediate voltage is supplied to the gas concentration sensor 200, for example. As a result, the accuracy of detecting the oxygen concentration in the exhaust gas can be suppressed from being lowered and the robustness of detecting the oxygen concentration in the exhaust gas can be improved.

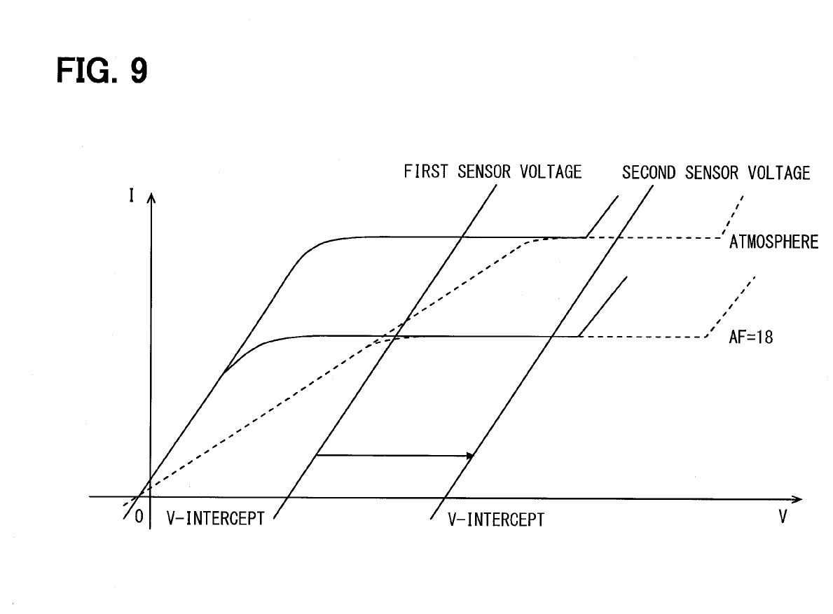

In the above-described embodiment, the inclination of the sensor voltage is exemplified to vary with the sensor current and the sensor temperature. However, as shown in FIG. 9, the inclination of the sensor voltage may be fixed to a constant value and the value of the sensor voltage in the V-axis of the V-I coordinate (the voltage value of the sensor voltage at the time the sensor current is zero, that is, V-intercept) may be adjusted in accordance with the sensor temperature. As described above, the first voltage at which the limiting-current starts to flow has the characteristic of the inverse proportion to the sensor voltage. For this reason, in the V-I coordinate, the first voltage approaches to the point of origin as the temperature rises and leaves from the point of origin as the temperature falls. The processing circuit 50 therefore decreases and increases the V-intercept as the sensor temperature rises and falls, respectively. That is, the processing circuit 50 moves the V-intercept toward the point of origin with the increase in the temperature and away from the point of origin with the decrease in the temperature. The V-intercept may thus be varied to follow the temperature-dependent variation of the first voltage. As a result, even when the temperature varies, it is possible to prevent that the limiting-current is disabled to flow in the gas concentration sensor 200 and thereby suppress that the accuracy in detecting the oxygen concentration in the exhaust gas is lowered. That is, robustness of the accuracy in detecting the oxygen concentration in the exhaust gas can be improved.

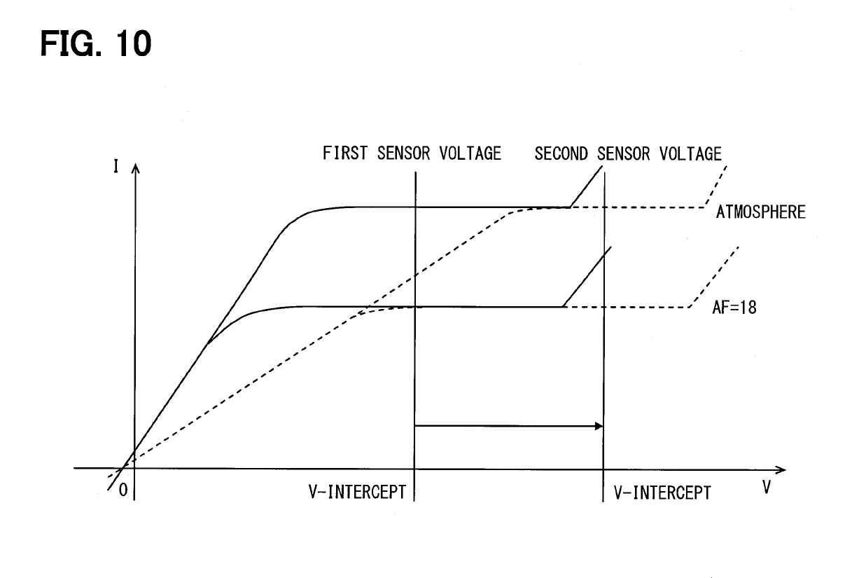

In FIG. 9, it is exemplified that the inclination of the sensor voltage is constant and the V-intercept is adjusted in accordance with the sensor temperature. However, as shown in FIG. 10, the inclination of the sensor voltage may be set to zero and only the V-intercept may be adjusted in accordance with the sensor temperature.

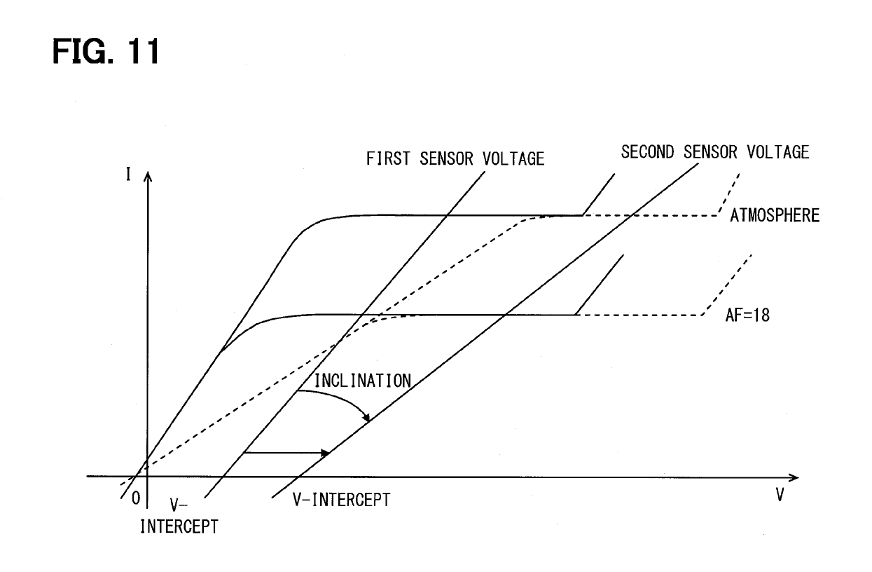

Furthermore, as shown in FIG. 11, the inclination of the sensor voltage may follow the sensor current and both of the inclination and the V-intercept may be adjusted in accordance with the sensor temperature. By thus adjusting the inclination and the V-intercept in accordance with the sensor temperature, the robustness of detecting the oxygen concentration in the exhaust gas can be more effectively improved. It is noted that the sensor voltage shown in FIG. 9 to FIG. 11 may be prestored in the processing circuit 50.

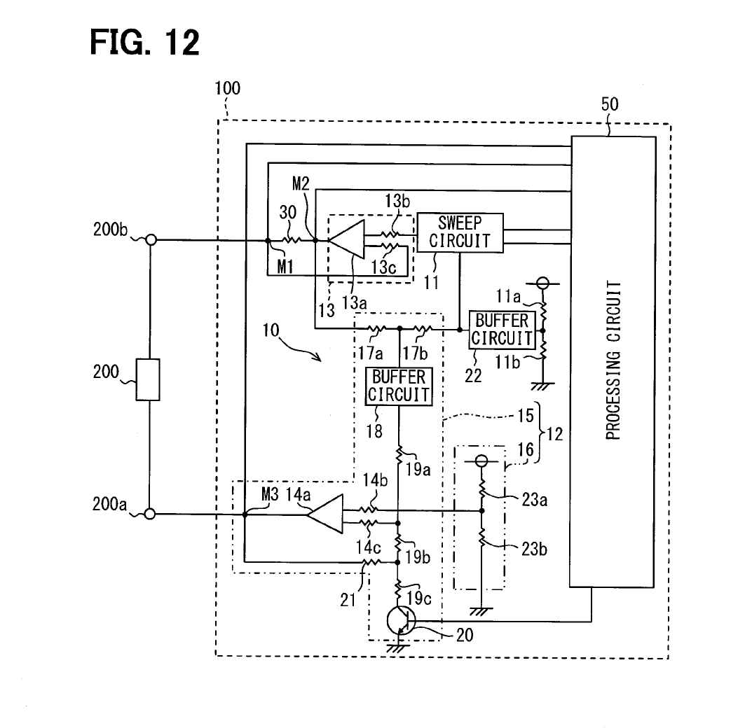

In the foregoing description, it is exemplified that the voltage supply circuit 12 is the DA converter circuit and the sensor voltage, which is shown in FIG. 8 to FIG. 11 and varying with the sensor voltage, is prestored in the processing circuit 50. It is also possible to not only convert the sensor voltage stored in the processing circuit 50 to the analog signal but also generate the sensor voltage shown in FIG. 8 to FIG. 11 by the control unit 100 shown exemplarily in FIG. 12 to FIG. 15.

A voltage supply circuit 12 shown in FIG. 12 is a differential amplifier circuit, which includes an inclination adjustment circuit 15 for adjusting the inclination of the sensor voltage and a V-intercept generation circuit 16 for generating the V-intercept of the sensor voltage, which is shown in FIG. 8. The inclination adjustment circuit 15 includes the second operational amplifier 14a and the input resistors 14b, 14c, which are structural elements of the second buffer 14 described above. The V-intercept generation circuit 16 has a function of inputting the voltage (V-intercept), which is generated when the sensor current is zero, to the second operational amplifier 14a.

The inclination adjustment circuit 15 is for increasing the sensor voltage in accordance with the sensor current. The inclination of the sensor voltage is varied by the processing circuit 50 in accordance with the sensor temperature. The inclination adjustment circuit 15 includes, in addition to the second operational amplifier 14a and the input resistors 14b, 14c, voltage dividing resistors 17a, 17b, a buffer circuit 18, series resistors 19a, 19b, 19c, a switch 20 and a feedback resistor 21. The gain of the second operational amplifier 14a is adjusted by resistances of the resistors 19a, 19b, 19c and the driving state of the switch 20, and hence the inclination of the sensor voltage is adjusted.

As shown in FIG. 12, a buffer circuit 22 is provided in a wire, which connects the second midpoint M2 and a midpoint between the two resistors 11a and 11b. The potential at the second midpoint M2 varies with variation of the sensor current. The voltage dividing resistors 17a and 17b are connected in series sequentially from the second midpoint M2 toward the buffer circuit 22. The buffer circuit 18, the series resistors 19a, 19b, 19c and the switch 20 are connected in series sequentially from the midpoint between the voltage dividing resistors 17a and 17b toward the ground. The midpoint between the series resistors 19a and 19b is connected to the other input terminal of the second operational amplifier 14a through the input resistor 14c. The midpoint between the series resistors 19b and 19c is connected to the third midpoint M3 through the feedback resistor 21. The V-intercept generation circuit 16 includes the voltage dividing resistors 23a and 23b connected in series from the power supply source toward the ground sequentially. Its midpoint is connected to one input terminal of the second operational amplifier 14a through the input resistor 14b.

With the configuration described above, the midpoint potential between the series resistors 19a and 19b and the midpoint potential between the voltage dividing resistors 23a and 23b are inputted to the second operational amplifier 14a. The midpoint potential between the series resistors 19a and 19b is determined in accordance with the sensor current (second midpoint voltage V2) and the driving state of the switch 20. The gain is determined in accordance with the driving state of the switch 20. The sensor voltage is outputted from the second operational amplifier 14a in accordance with the input voltage and the gain. The midpoint potential between the series resistors 19a and 19b decreases as the sensor current, which flows from the first midpoint M1 to the second midpoint M2, increases. The difference value between the midpoint potential between the series resistors 19a and 19b and the midpoint potential between the voltage dividing resistors 23a and 23b thus increases. As a result, the sensor voltage increases following the increase in the sensor current as shown in FIG. 8. By controlling the driving state of the switch 20, the resistance value at the more ground side than the series resistor 19a is varied and hence the gain of the second operational amplifier 14a is adjusted. As a result, the gain of the sensor voltage relative to the sensor current is adjusted and the inclination of the sensor voltage is adjusted as shown in FIG. 8. The driving state of the switch 20 is controlled by the processing circuit 50 in accordance with the sensor temperature. By controlling the on-resistance of the switch 20 to vary continuously in accordance with the sensor temperature by the processing circuit 50, the inclination of the sensor voltage is varied continuously. Since the voltage outputted from the V-intercept generation circuit 16 is constant irrespectively of the sensor current, the voltage value of the sensor voltage developed when the sensor current is zero is constant as shown in FIG. 8.

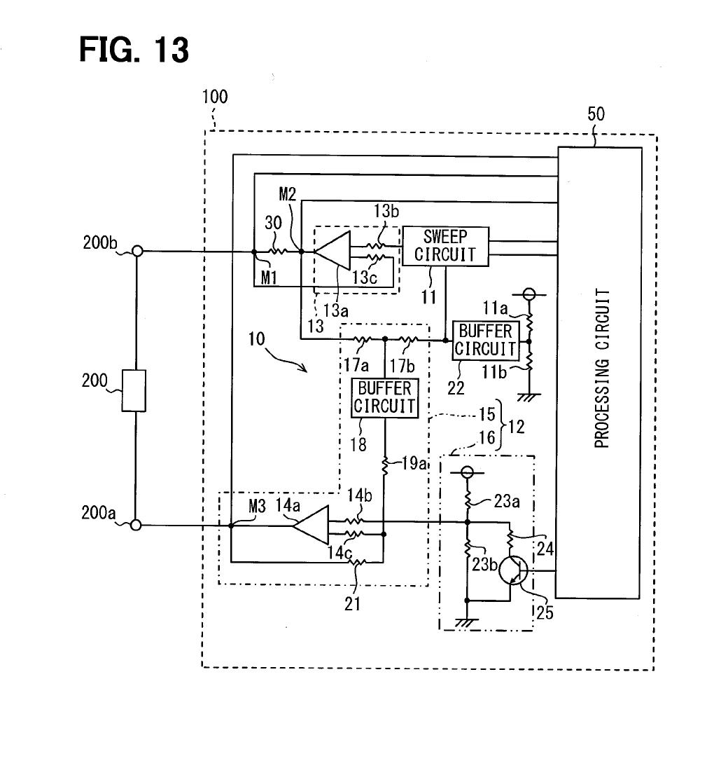

The voltage supply circuit 12 shown in FIG. 13 is also a differential amplifier circuit and includes the inclination adjustment circuit 15 and the V-intercept generation circuit 16. The inclination adjustment circuit 15 shown in FIG. 13 is not provided with the series resistor 19c nor the switch 20 differently from the voltage supply circuit 12 shown in FIG. 12. Thus the inclination of the sensor voltage is constant independently of the sensor temperature as shown in FIG. 9. However, the V-intercept generation circuit 16 includes a resistor 24 and a switch 25 in addition to the voltage dividing resistors 23a and 23b. The resistor 24 and the switch 25 are connected in series from the midpoint between the voltage dividing resistors 23a and 23b toward the ground sequentially and in parallel to the voltage dividing resistor 23b. By controlling the driving state of the switch 25, the resistance value at the more ground side than the voltage dividing resistor 23a is varied and hence the V-intercept voltage is varied digitally as shown in FIG. 9. The driving state of the switch 25 is controlled by the processing circuit 50 in accordance with the sensor temperature.

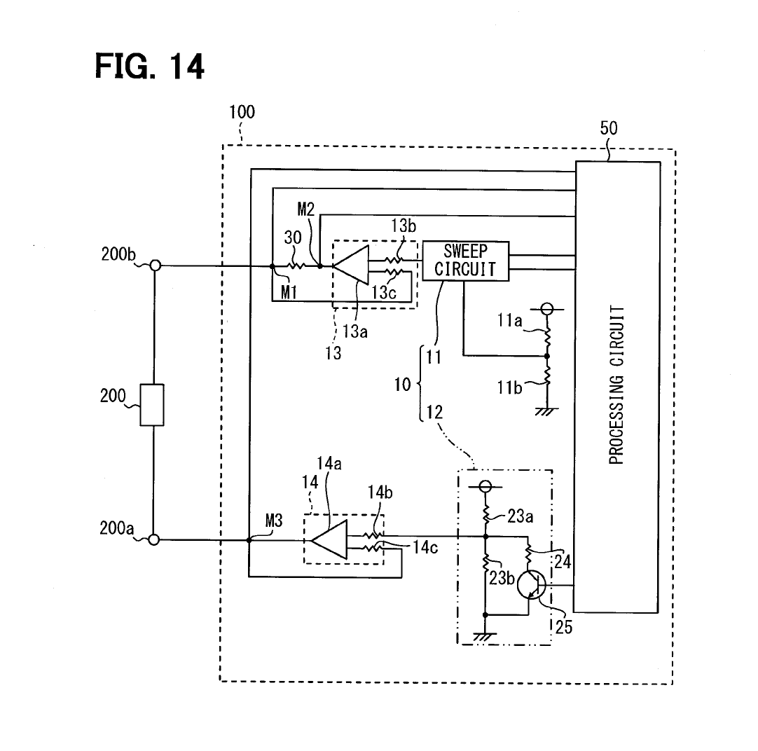

The voltage supply circuit 12 shown in FIG. 14 includes only the V-intercept generation circuit 16 shown in FIG. 13. The inclination of the sensor voltage is therefore zero as shown in FIG. 10. However, by controlling the driving state of the switch 25 in the V-intercept generation circuit 16 in accordance with the sensor temperature by the processing circuit 50, the V-intercept voltage is varied digitally in accordance with the sensor temperature as shown in FIG. 10.

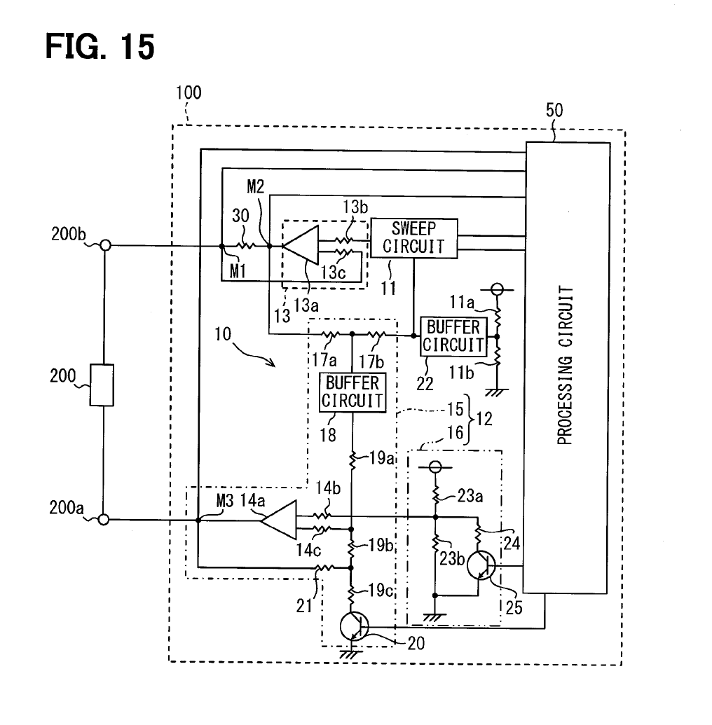

The voltage supply circuit 12 shown in FIG. 15 includes the inclination adjustment circuit 15 shown in FIG. 12 and the V-intercept generation circuit 16 shown in FIG. 13. By controlling the driving states of the switch 20 of the inclination adjustment circuit 15 and the switch 25 of the V-intercept generation circuit 16 in accordance with the sensor temperature, the inclination of the sensor voltage and the V-intercept voltage are varied as shown in FIG. 11.

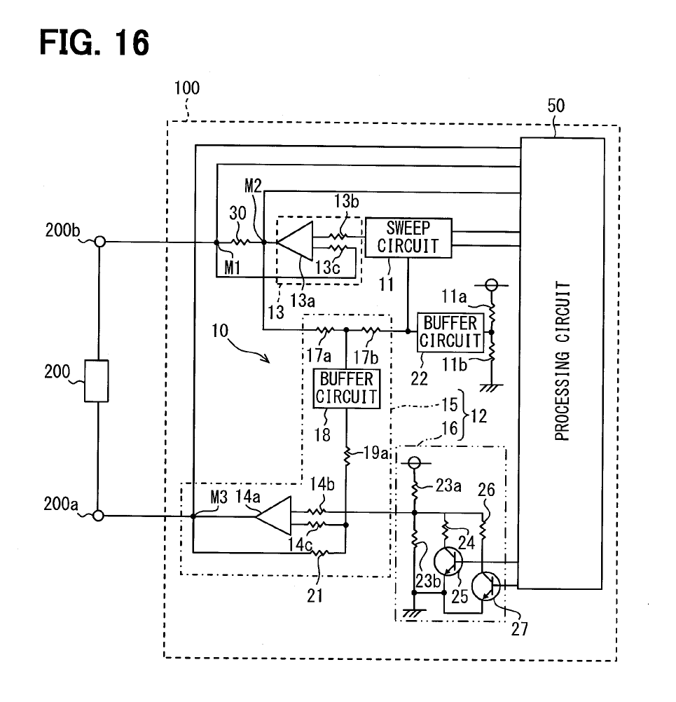

In FIG. 13, the V-intercept generation circuit 16 is exemplified as including, in addition to the voltage dividing resistors 23a and 23b, the resistor 24 and the switch 25 connected in parallel to the voltage dividing resistor 23b. The number of the resistor 24 and the switch 25 connected in parallel to the voltage dividing resistor 23b may be plural. For example, as shown in FIG. 16, the V-intercept generation circuit 16 may be configured to include a resistor 26 and a switch 27, which are connected in parallel to the voltage dividing resistor 23b, as well as the resistor 24 and the switch 25. In this configuration, by controlling the driving states of the switches 25 and 27 in accordance with the sensor temperature by the processing circuit 50, four kinds of V-intercepts are provided. The four kinds of V-intercepts are provided by combining an on-state and an off-state of the switches 25 and 27.

In FIG. 12, the inclination adjustment circuit 15 is exemplified as including the series resistor 19c and the switch 20 in addition to the second operational amplifier 14a, the input resistors 14b, 14c, the voltage dividing resistors 17a, 17b, the buffer circuit 18, the series resistors 19a, 19b and the feedback resistor 21. The number of the series resistor 19c and the switch 20 is not limited to the above-described numbers but may be plural. Although not shown, it is also possible to connect plural sets of the series resistor 19c and the switch 20, which are connected in series, in parallel. For example, in a configuration that two sets of the series resistor 19c and the switch 20, which are connected in series, are connected in parallel, four kinds of inclinations are provided by controlling the driving states of the two switches 20 in accordance with the sensor temperature by the processing circuit 50. The four kinds of inclinations are provided by combining an on-state and an off-state of the two switches 20.

In the foregoing embodiment, the control unit 100 is exemplified to control the gas concentration sensor 200, which detects the oxygen concentration contained in the exhaust gas of the internal combustion engine. The control unit 100 is not limited to control the gas concentration sensor described above but may control other gas concentrations such as H₂O or CO₂ contained in gases to be detected.

In the foregoing embodiment, the sensor voltage is exemplified as the linear line in the V-I coordinate. However, the sensor voltage is not limited to such an example but may be a curved line in the V-I coordinate. For controlling the sensor voltage represented as the curved line, such a curved line may be prestored in the processing circuit 50.

In the foregoing embodiments, as one example, the driving temperature region of the gas concentration sensor 200 is divided into two temperature regions and the first sensor voltage and second sensor voltage corresponding respectively to the divided two temperature regions are prestored in the processing circuit 50. The number of division of the driving temperature region is not limited to the above-described example but may be three or more. In this case, three or more sensor voltages corresponding to three or more temperature regions may be prestored in the processing circuit 50.

In the foregoing embodiments, the characteristic of the sensor voltage is exemplified to pass the intermediate voltage in the V-I coordinate. However, as long as the limiting-current flows in response to the supply of the sensor voltage independently of the temperature, the characteristic of the sensor voltage need not be determined to pass the intermediate voltage point in the V-I coordinate.

What is claimed is:

1. A control unit for controlling a gas concentration sensor, in which current flows in accordance with a resistance thereof in response to a sensor voltage supplied thereto, the current saturating at a limiting-current corresponding to a concentration of a gas, which is to be detected, irrespectively of the sensor voltage supplied thereto when the sensor voltage supplied thereto exceeds a predetermined value, the control unit comprising:
a voltage control circuit for controlling the sensor voltage supplied to the gas concentration sensor;
a current detection resistor for detecting the current flowing in the gas concentration sensor; and
a calculation circuit for calculating a temperature of the gas concentration sensor,
wherein the voltage control circuit includes a voltage supply circuit for supplying the sensor voltage so that the limiting-current flows in the gas concentration sensor, and
wherein the voltage supply circuit controls the sensor voltage supplied to the gas concentration sensor in accordance with the temperature of the gas concentration sensor, so that the limiting-current corresponding to the temperature of the gas concentration sensor calculated by the calculation circuit flows in the gas concentration sensor irrespectively of the concentration of the gas to be detected.

2. The control unit according to claim 1, wherein:
the voltage supply circuit controls the sensor voltage supplied to the gas concentration sensor in correspondence to the current of the gas concentration sensor by increasing and decreasing an inclination of the sensor voltage supplied to the gas concentration sensor in accordance with an increase and decrease of the temperature of the gas concentration sensor, the inclination being determined by dividing a current variation quantity by a voltage variation quantity in a voltage-current coordinate, which defines a relation between a sensor voltage supplied to the gas concentration sensor and a current flowing in the gas concentration sensor.

3. The control unit according to claim 2, wherein:
the voltage supply circuit controls the sensor voltage supplied to the gas concentration sensor so that an intermediate voltage of the limiting-current corresponding to the temperature of the gas concentration sensor is supplied to the gas concentration sensor,
the intermediate voltage is intermediate between a first voltage, which is required for the limiting-current to flow, and a second voltage, which is required for a current larger than the limiting-current to start to flow.

4. The control unit according to claim 1, wherein:
the voltage supply circuit decreases and increases a value of the sensor voltage supplied to the gas concentration sensor on a voltage-axis in a voltage-current coordinate, which defines a relation between a voltage supplied to the gas concentration sensor and a current flowing in the gas concentration sensor, in accordance with an increase and decrease of the temperature of the gas concentration sensor.

5. The control unit according to claim 2, wherein:
the voltage supplied to the gas concentration sensor by the voltage supply circuit is represented as a linear line in the voltage-current coordinate.

6. The control unit according to claim 1, wherein:
the voltage supply circuit divides a driving temperature region of the gas concentration sensor into first to N-th temperature regions with N being a natural number equal to 2 or more, and sets first to N-th voltages in correspondence to the first and N-th temperature regions, respectively, as the sensor voltage supplied to the gas concentration sensor; and
the voltage supply circuit supplies the gas concentration sensor with a k-th sensor voltage, which corresponds to a k-th temperature region, with k being a natural number equal to 1 or more and equal to N and less, when the temperature of the gas concentration sensor is in the k-th temperature region.

7. The control unit according to claim 6, wherein:
the voltage supply circuit calculates voltages having characteristics, which allow the limiting-current of each concentration to flow in each of first to L-th measurement temperatures, each measurement temperature being determined by equally dividing the k-th temperature region by a natural number L with L being equal to or larger than 2; and
the voltage supply circuit determines the k-th sensor voltage by selecting a voltage, which has a common characteristic for each of the first to L-th measurement temperatures, based on calculated voltages having plural characteristics.

8. The control unit according to claim 1, wherein:
The voltage control circuit includes a sweep circuit for supplying the gas concentration sensor with a sweep voltage, a voltage value of which varies with time to detect a temperature of the gas concentration sensor, and
the calculation circuit prestores a temperature characteristic of impedance or admittance of the gas concentration sensor, calculates the impedance or admittance based on a variation of the current flowing in the gas concentration sensor and a variation of the sweep voltage supplied to the gas concentration sensor by the sweep circuit, and calculates the temperature of the gas concentration sensor based on a calculated impedance or admittance and the temperature characteristic of the impedance or admittance.

9. A control unit for controlling a gas concentration sensor, in which a current flows in accordance with a resistance thereof in response to a sensor voltage supplied thereto, the current saturating at a limiting-current corresponding to a concentration of a gas, which is to be detected, irrespectively of the sensor voltage when the sensor voltage exceeds a predetermined value, the control unit comprising:
a current detection resistor for detecting the current flowing in the gas concentration sensor; and
a calculation circuit for calculating a temperature of the gas concentration sensor,
wherein the calculation circuit calculates a value of the sensor voltage supplied to the gas concentration sensor in accordance with the temperature of the gas concentration sensor, so that the limiting current, which is detected by the current detection resistor and corresponds to the temperature of the gas concentration sensor calculated by the calculation circuit, flows in the gas concentration sensor irrespectively of the concentration of the gas to be detected.

10. The control unit according to claim 9, further comprising:
a sweep circuit for periodically supplying the gas concentration sensor with a sweep voltage, a voltage value of which varies with time, separately from the sensor voltage,
wherein the calculation circuit calculates impedance or admittance based on a voltage variation and a current variation of the gas concentration sensor caused by supply of the sweep voltage to the gas concentration sensor thereby to calculate the temperature of the gas concentration sensor.
